(19) United States
(12) Patent Application Publication
(10) Pub. No.: US 2026/0260798 A1
(43) Pub. Date: Sep. 3, 2026

(54) ARMATURE UNIT AND LINEAR MOTOR

(71) Applicant: FANUC CORPORATION, Yamanashi (JP)

(72) Inventor: Daisuke NAKAYAMA, Yamanashi (JP)

(21) Appl. No.: 18/867,006

(22) PCT Filed: Jun. 20, 2022
(86) PCT No.: PCT/JP2022/024535

§ 371 Date: Nov. 19, 2024

(51) Int. Cl. H01F 7/08; H02K 41/02

(52) U.S. Cl. CPC H01F 7/081; H01F 2007/086; H02K 41/02

(57) ABSTRACT

This armature unit comprises an armature and a gasket which can be disposed between a machine table and the armature and which has at least one rubber layer and a metal layer

### TECHNICAL FIELD

The present disclosure relates to an armature unit and a linear motor.

### BACKGROUND ART

Conventionally, a linear motor for driving a machine table has been known (for example, Patent Document 1).

### CITATION LIST

### Patent Document

Patent Document 1: JP 2004-343873 A

### SUMMARY OF INVENTION

### Technical Problem

A linear motor for driving a machine table is used in various environments. For example, when the linear motor is used in a machine tool, there is concern that cutting fluid or cutting chips may enter an armature, causing a defect of the armature.

Therefore, there is a demand for an armature unit that can prevent foreign matter from entering.

### Solution to Problem

An armature unit includes an armature, and a gasket having at least one rubber layer and a metal layer allowed to be disposed between a machine table and the armature.

The armature gasket has at least two rubber layers and a metal layer interposed between the at least two rubber layers.

### Advantageous Effects of Invention

The present disclosure enables the prevention of foreign matter from entering the armature.

### BRIEF DESCRIPTION OF DRAWINGS

FIG. 1 is a perspective view illustrating an example of an armature unit;

FIG. 2 is a side view illustrating an example of a gasket having a rubber layer and a metal layer;

FIG. 3 is a cross-sectional view illustrating an example of the armature unit to which a machine table is fixed;

FIG. 4 is a cross-sectional view illustrating an example of the armature unit including a cooling plate;

FIG. 5 is a perspective view illustrating an example of the armature unit;

FIG. 6 is a cross-sectional view illustrating an example of the armature unit to which the machine table is fixed;

FIG. 7 is a cross-sectional view illustrating an example of the armature unit including a plate;

FIG. 8 is a perspective view illustrating an example of the armature unit;

FIG. 9A is a cross-sectional view illustrating an example of the armature unit;

FIG. 9B is a cross-sectional view illustrating the example of the armature unit;

FIG. 10 is a diagram illustrating an example of the gasket in which an uneven portion is formed to surround a plurality of bolt holes;

FIG. 11 is a cross-sectional view illustrating an example of the machine table and the armature unit;

FIG. 12 is a diagram illustrating another example of the gasket in which the uneven portion is formed to surround a plurality of bolt holes; and

FIG. 13 is a diagram illustrating another example of the gasket in which the uneven portion is formed to surround a plurality of bolt holes.

### DESCRIPTION OF EMBODIMENTS

Hereinafter, an armature unit and an armature gasket according to an embodiment of the disclosure will be described with reference to the drawings.

Note that not all combinations of features described in the following embodiment are necessarily required to solve the problem. In addition, more detailed description than necessary may be omitted. In addition, the following description of the embodiment and the drawings are provided to enable those skilled in the art to fully understand the disclosure, and are not intended to limit the scope of the claims.

The armature unit is an armature unit for a linear motor. For example, the linear motor drives a machine table of a machine tool or a measuring device.

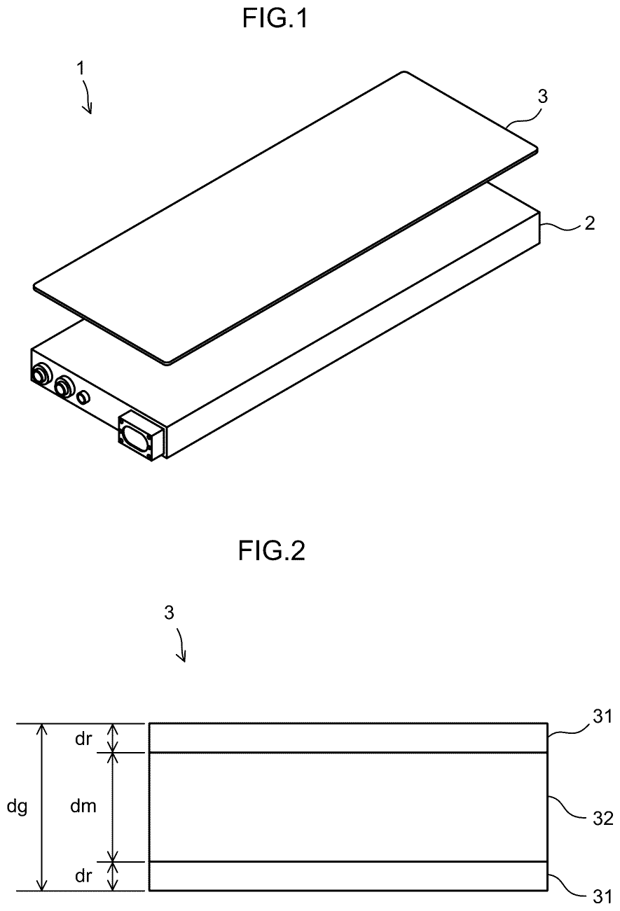

FIG. 1 is a perspective view illustrating an example of the armature unit. The armature unit 1 includes an armature 2 and a gasket 3 having at least one rubber layer that can be disposed between the machine table and the armature 2.

The armature 2 is a member having winding that generates an induced electromotive force by relative motion with a magnetic field. The armature 2 has, for example, a rectangular parallelepiped shape with each face being a rectangular face, and has winding inside. The armature 2 moves along a stator (not illustrated) that generates a magnetic field.

The machine table is a member on which an object is placed. When the machine table is used in a machine tool, a workpiece is placed on the machine table as an object. When the machine table is used in a measuring device, an object to be measured is placed as an object on the machine table. The machine table is formed, for example, in a rectangular parallelepiped shape with each face being a rectangular face.

The gasket 3 is a sealing material for imparting airtightness and liquid-tightness to a structure. The gasket 3 is formed, for example, in the same rectangular shape as that of an upper surface of the armature 2. The gasket 3 may have at least two rubber layers and a metal layer interposed between the at least two rubber layers.

The rubber layer is a layer of a polymeric compound having elasticity. The polymeric compound is, for example, an elastomer. The rubber layer is a thin sheet-shaped member.

The metal layer is made of a thin plate-shaped metal. For example, the metal is stainless steel.

FIG. 2 is a side view illustrating an example of the gasket 3 having a rubber layer and a metal layer. The gasket 3 has two rubber layers 31 and a metal layer 32 interposed between the two rubber layers 31. For example, the rubber layers 31 and the metal layer 32 are bonded to each other using an adhesive, etc.

A thickness dg of the gasket 3 is 0.1 [mm] or more and 5 [mm] or less. In addition, a thickness dr of one of the rubber layers 31 is 0.01 [mm] or more and 0.1 [mm] or less. Note that, when the thickness dr of the one rubber layer 31 is, for example, 0.1 [mm], a thickness dg of the gasket 3 is at least greater than 0.2 [mm], and obviously is greater than a lower limit of 0.1 [mm] of the thickness dg of the gasket 3 described above.

In the gasket 3 illustrated in FIG. 2, the thickness dm of the metal layer 32 is 0.2 [mm], the thickness dr of the one rubber layer 31 is 0.025 [mm], and a total thickness is 0.25 [mm].

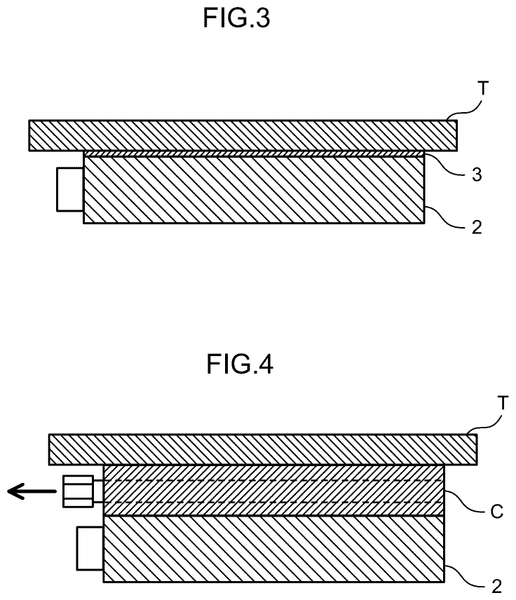

FIG. 3 is a cross-sectional view illustrating an example of the armature unit 1 to which the machine table is fixed. The gasket 3 is interposed between the armature 2 and the machine table T. In this way, it is possible to prevent foreign matter such as cutting fluid from entering between the armature 2 and the gasket 3. In other words, the armature 2 can be waterproofed by metal touch of the metal layer 32 included in the gasket 3. Note that the machine table T and the armature 2 may be fixed to each other by, for example, a known clamp member.

For example, even when a liquid sealant is applied between the armature 2 and the machine table T, the armature 2 can be waterproofed. However, since the liquid sealant also has properties of an adhesive, it becomes difficult to remove the machine table T from the armature 2. Furthermore, uneven coating of the liquid sealant is likely to occur, in which case the armature 2 cannot be sufficiently waterproofed. Therefore, for example, when holes are formed in a surface of the armature 2, there is concern that cutting fluid, etc. may enter through the holes.

Meanwhile, the armature unit 1 of the disclosure includes the armature 2 and a gasket 3 having at least one rubber layer 31 and a metal layer 32 that can be disposed between the machine table T and the armature 2. Therefore, since the gasket 3 is not a sealant, the machine table T can be easily removed from the armature 2. In other words, a maintenance property of the armature unit 1 of the disclosure is high. Furthermore, a problem such as uneven coating during manufacturing does not occur.

Furthermore, the armature unit 1 of the disclosure includes the rubber layer 31, and thus has high heat-insulating properties. In other words, it is possible to prevent heat generated in the armature 2 from being transmitted to the machine table T. Therefore, it is possible to prevent the machine table T from being deformed by heat. As a result, when the machine table T is used in the machine tool, it is possible to improve machining accuracy of the workpiece. In addition, when the machine table T is used in the measuring device, it is possible to improve measurement accuracy of the object to be measured.

For example, by disposing a cooling plate C including a cooling pipe between the armature 2 and the machine table T, it is possible to prevent heat generated in the armature 2 from being transmitted to the machine table T (see FIG. 4). However, the cooling plate C is thick, which makes the armature unit 1 larger. Furthermore, a chiller is required to cool cooling water, which makes the machine larger. Moreover, the chiller consumes a large amount of energy. As a result, carbon dioxide emission increases.

Meanwhile, the gasket 3 of the armature unit 1 is thin, and thus the armature unit 1 can be made smaller. The thickness dr of the one rubber layer 31 is 0.01 [mm] or more and 0.1 [mm] or less. In addition, a thickness of the gasket is 0.1 [mm] or more and 5 [mm] or less.

By setting the thickness dr of the rubber layer 31 and the thickness of the gasket in this way, it is possible to increase joint rigidity between the armature 2 and the machine table T. As a result, the machine table T becomes less likely to vibrate, and positioning accuracy of the machine table T is improved.

Furthermore, the armature unit 1 of the disclosure does not use a chiller. For this reason, it is possible to suppress energy consumption.

The greatest advantage of the armature unit 1 of the disclosure is that it is possible to simultaneously achieve the above-mentioned effects of waterproofness, maintenance, ease of manufacture, heat-insulating properties, miniaturization, and suppression of energy consumption.

In the above-described embodiment, no holes are formed in the gasket 3. However, when the machine table T is fixed to the armature 2 by bolts, bolt holes may be formed in the gasket 3.

FIG. 5 is a perspective view illustrating an example of the armature unit 1. Threaded holes 21 for bolts are formed in the upper surface of the armature 2. The table is fixed to the armature 2 using the threaded holes 21. In addition, a plurality of bolt holes 33 for inserting bolts is formed in the gasket 3 at positions corresponding to the threaded holes 21. The bolt holes 33 are formed, for example, by laser machining.

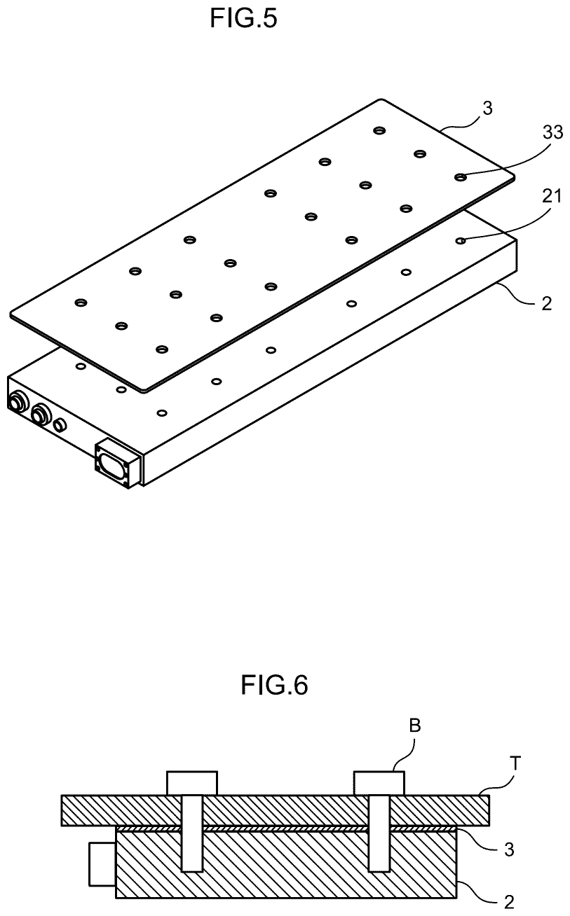

FIG. 6 is a cross-sectional view illustrating an example of the armature unit 1 to which the machine table T is fixed. The gasket 3 is interposed between the armature 2 and the machine table T. Bolts B are inserted into the holes in the table and the bolt holes 33 in the gasket 3, and are then fastened into the threaded holes 21 in the armature 2. In this way, it is possible to prevent liquid from entering between the machine table T and the armature 2. As a result, it is possible to prevent liquid from entering the threaded holes 21 in the armature 2.

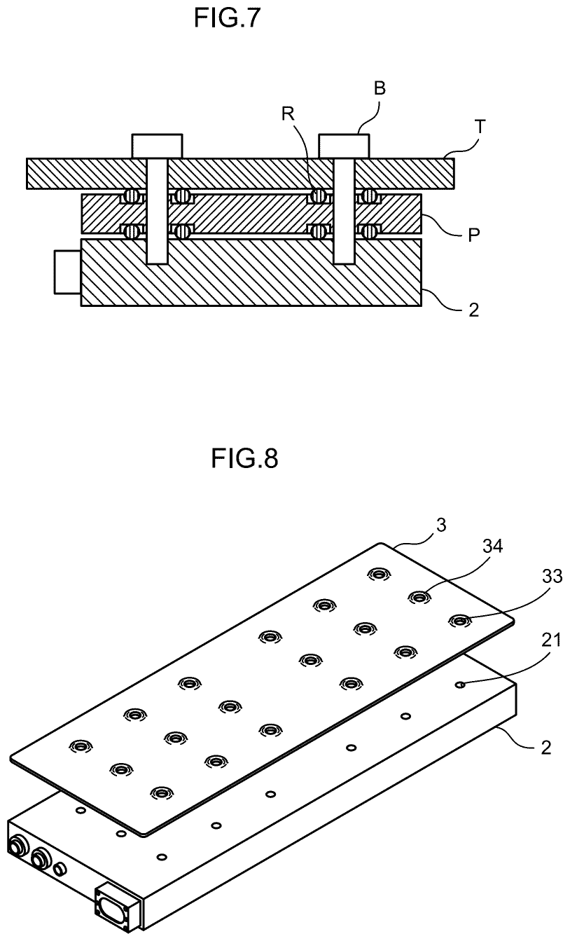

To prevent liquid from entering the threaded holes 21 formed in the armature 2, for example, a plate P equipped with O-rings R can be disposed around the bolt B (see FIG. 7). In this case, it is possible to prevent liquid from entering between the machine table T and the plate P, and between the plate P and the armature 2. However, in this case, the armature unit 1 increases in size by a thickness of the plate P. In addition, the plate P cannot prevent heat generated in the armature 2 from being transmitted to the machine table T.

On the other hand, the gasket 3 of the armature unit 1 has a small thickness, and thus the armature unit 1 can be miniaturized. In addition, the gasket 3 has the rubber layer 31, and thus a heat insulating effect can be exhibited.

Even though the gasket 3 in the above-described embodiment does not have any unevenness, the gasket 3 may have unevenness at positions surrounding the bolt holes 33.

FIG. 8 is a perspective view illustrating an example of the armature unit 1. Uneven portions 34 are formed around the bolt holes 33. The uneven portions 34 are formed, for example, by a press machine. That is, the metal layer 32 of the gasket 3 is plastically deformed by a pressing process to form the uneven portions 34.

An uneven portion 34 is formed to surround one bolt hole 33. In other words, a plurality of uneven portions 34 is formed to surround the respective bolt holes 33 in the gasket 3.

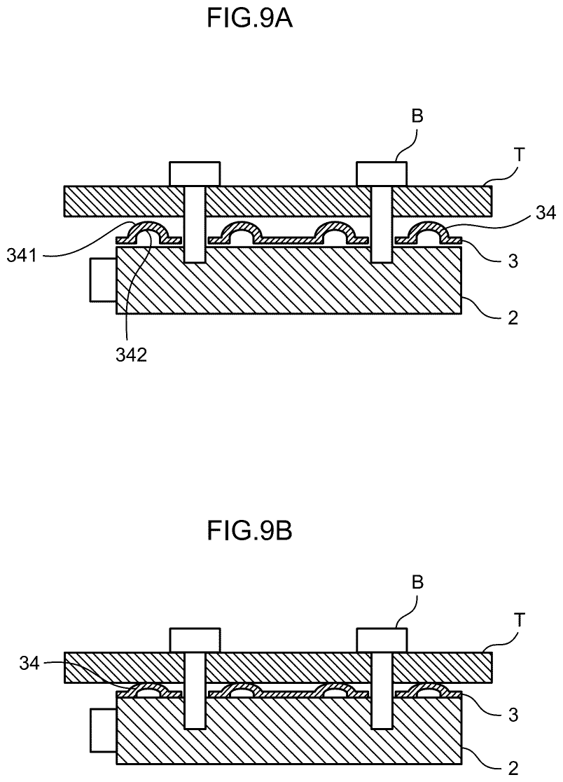

FIGS. 9A and 9B are cross-sectional views illustrating an example of the armature unit 1 to which the machine table T is fixed. FIG. 9A illustrates a state before the bolts B are tightened. In addition, FIG. 9B illustrates a state after the bolts B are tightened.

The gasket 3 has a first surface and a second surface on a rear side of the first surface. In FIGS. 9A and 9B, a surface in contact with the machine table T is the first surface. In addition, a surface in contact with the armature 2 is the second surface. A convex portion 341 is formed on the first surface, and a concave portion 342 is formed on the second surface at a position corresponding to the convex portion 341. In addition, as described above, the concave portion 342 and the convex portion 341 are formed to surround the one bolt hole 33.

When the bolts B are fastened into the threaded holes 21 formed in the armature 2, a top portion of the convex portion 341 receives a pressing force from a lower surface of the machine table T. In this way, pressure acting on a contact surface between the machine table T and the gasket 3 and pressure acting between the armature 2 and the gasket 3 increase. The gasket 3 of the disclosure is different from an ordinary gasket and includes the metal layer 32 in addition to the rubber layer 31. Therefore, a metal touch bonding force by the metal layer 32 increases, and contact pressure can be further increased as described above. As a result, it is possible to stably prevent liquid from entering between the machine table T and the armature 2.

In addition, a small space is formed between the concave portion 342 of the gasket 3 and the upper surface of the armature 2. This space contains air. Therefore, an air layer is formed between the armature 2 and the gasket 3, and the heat insulating effect of the gasket 3 can be enhanced.

In the embodiment described above, the uneven portion 34 is formed to surround the one bolt hole 33. However, the uneven portion 34 may be formed to surround a plurality of bolt holes 33.

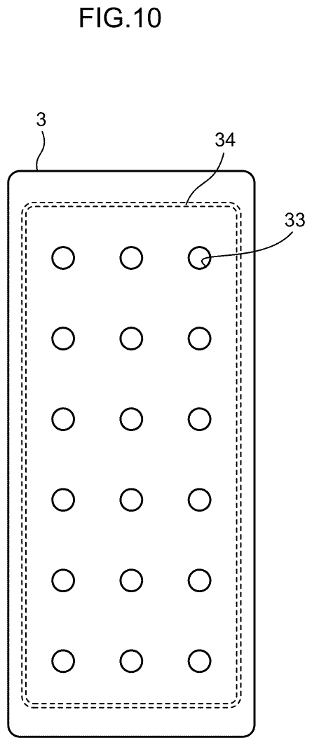

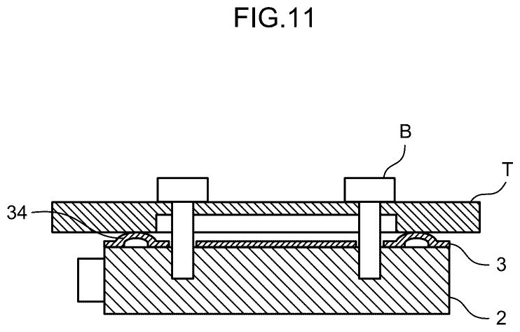

FIG. 10 is a diagram illustrating an example of the gasket 3 in which the uneven portion 34 is formed to surround a plurality of bolt holes 33. In the gasket 3 illustrated in FIG. 10, the uneven portion 34 is formed to surround all the bolt holes 33. In this case, the lower surface of the machine table T may be in contact with the uneven portion 34 of the gasket 3. In other words, a region inside a portion in contact with the uneven portion 34 does not necessarily need to be in contact with the gasket 3. Therefore, as illustrated in FIG. 11, a thickness of the region inside the portion in contact with the uneven portion 34 can be made thinner than a thickness of the region in contact with the uneven portion 34. In this way, the machine table T can be made lighter.

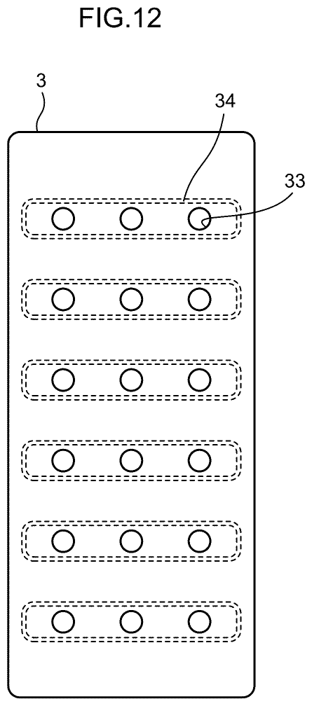

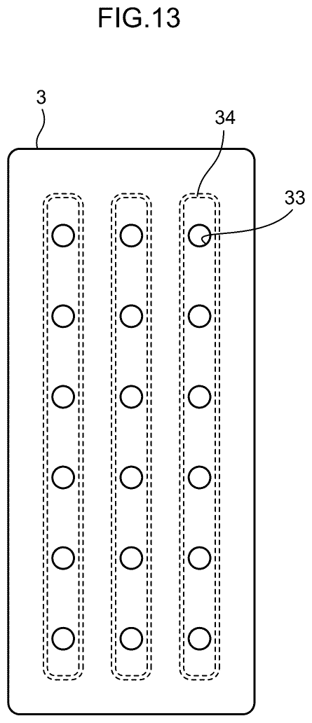

FIGS. 12 and 13 are diagrams each illustrating another example of the gasket 3 in which the uneven portion 34 is formed to surround a plurality of bolt holes 33.

In the gasket 3 illustrated in FIG. 12, the uneven portion 34 is formed to surround a plurality of bolt holes 33 aligned in a direction perpendicular to a longitudinal direction of the gasket 3. In the gasket 3 illustrated in FIG. 13, the uneven portion 34 is formed to surround a plurality of bolt holes 33 aligned in the longitudinal direction of the gasket 3. In this way, it is possible to reduce the number of pressing processes required to form the uneven portion 34 when compared to forming the uneven portion 34 around each bolt hole 33.

Note that the disclosure is not limited to the above-described embodiment, and may be modified as appropriate without departing from intent of the disclosure. For example, any of the components of the embodiment of the disclosure may be modified or omitted.

### REFERENCE SIGNS LIST

1 ARMATURE UNIT
2 ARMATURE
21 THREADED HOLE
3 GASKET
31 RUBBER LAYER
32 METAL LAYER
33 BOLT HOLE
34 UNEVEN PORTION
341 CONVEX PORTION
342 CONCAVE PORTION
T MACHINE TABLE
B BOLT
C COOLING PLATE
P PLATE
R O-RING

1. An armature unit comprising:
an armature; and
a gasket having at least one rubber layer and a metal layer allowed to be disposed between a machine table and the armature.

2. The armature unit according to claim 1, wherein the gasket has at least two rubber layers and a metal layer interposed between the at least two rubber layers.

3. The armature unit according to claim 1, wherein a thickness of the at least one rubber layer is 0.01 [mm] or more and 0.1 [mm] or less.

4. The armature unit according to claim 1, wherein a thickness of the gasket is 0.1 [mm] or more and 5 [mm] or less.

5. The armature unit according to claim 1, wherein a bolt hole is formed in the gasket.

6. The armature unit according to claim 5, wherein the gasket has a first surface and a second surface on a rear side of the first surface, a convex portion is formed on the first surface, a concave portion is formed on the second surface at a position corresponding to the convex portion, and the concave portion and the convex portion are formed to surround one or more of the bolt holes.

7. A linear motor comprising the armature unit according to claim 1.
